(19) United States
(12) Patent Application Publication
(10) Pub. No.: US 2026/0300628 A1
(43) Pub. Date: Oct. 1, 2026

(54) MACHINE LEARNING BASED ENTITY EXTRACTION

(71) Applicant: CoreLogic Solutions, LLC, Irvine, CA (US)

(72) Inventors: Chen Qiu, San Diego, CA (US); Ying Wang, Dallas, TX (US); Chun-Jou Hsiang, Encinitas, CA (US); Fabien Pierre Emile Huard, Irvine, CA (US)

(21) Appl. No.: 19/631,942

(22) Filed: Mar. 27, 2026

Related U.S. Application Data
(60) Provisional application No. 63/781,166, filed on Mar. 31, 2025.

(51) Int. Cl. G06F 40/295; G06F 40/30; G06N 20/20

(52) U.S. Cl. CPC G06F 40/295; G06F 40/30; G06N 20/20

(57) ABSTRACT

Embodiments disclosed herein relate to systems for training and implementing models to extract entities from legal descriptions for further property-related determinations. Specifically, the entity-based search system comprises a plurality of entity services, each configured to access a model for extraction of a particular entity. In a training phase, the entity-based search system may generate a set of training data to specifically train each model for extraction of a particular entity. To curate a training data set, the entity-based search system may implement distance-based calculations to determine a diverse set of training descriptions. The training set may be labeled with ground truth data corresponding to the embedded entities within the description. In an inference phase, the entity-based search system may access a legal description and prompts for input into the model. Each model may be configured to extract entities from the legal description.

### CROSS-REFERENCE TO RELATED APPLICATIONS

The present application claims priority from U.S. Provisional No. 63/781,166, filed on Mar. 31, 2025, entitled MACHINE LEARNING BASED ENTITY EXTRACTION, which is hereby incorporated by reference herein in its entirety.

### BACKGROUND

Legal descriptions include any written statement that delineates the boundaries of a piece of real property. Legal descriptions can include any information identifying the piece of real property, such as distance, direction, reference points, and even subdivision information such as lot or block numbers (“entities”). Entities can be used to search public record databases for tax liability.

### SUMMARY

The systems, methods, and devices of this disclosure each have several innovative aspects, no single one of which is solely responsible for all of the desirable attributes disclosed herein. Details of one or more implementations of the subject matter described in this specification are set forth in the accompanying drawings and descriptions below.

In some aspects, the techniques described herein relate to a method, comprising: training a plurality of machine learning (ML) models configured to extract at least one entity from a property description, wherein training comprises: accessing candidate descriptions; calculating a plurality of semantic distances, wherein the plurality of semantic distances includes a semantic distance between each of the candidate descriptions; determining a set of training descriptions from the candidate descriptions, wherein the set of training descriptions comprises at least two candidate descriptions with a semantic distance above a distance threshold; labeling each description of the set of training descriptions with at least one ground truth entity; providing the set of training descriptions as input to the plurality of ML models, wherein the plurality of plurality of ML models are configured to output the at least one ground truth entity for each description of the set of training descriptions.

In some aspects, the techniques described herein relate to a method, wherein the at least one entity includes one of an accessor's parcel number (APN), condo unit, condo name, parking unit, building, fully subject lot, partial subject lot, condo lot, subject acreage, exceptional acreage, storage unit, block, square, subdivision, phase, state, tract, county, situs address, metes and bounds, and the like.

In some aspects, the techniques described herein relate to a method, wherein the ML model is a large language model.

In some aspects, the techniques described herein relate to a method, comprising: determining an inference based on extracted entities, wherein determination comprises: accessing a property description; providing the property description and a prompt as input to at least one machine learning (ML) model of a plurality of ML models, wherein the at least one ML model is configured to extract, based on the prompt, at least one entity from the property description; and providing the at least one extracted entity to a public record database system, the public record database system to determine the inference, wherein the inference comprises a tax liability corresponding to the property.

In some aspects, the techniques described herein relate to a computer-implemented method, comprising: training a plurality of machine learning (ML) models to extract entities from a property description, wherein each model of the plurality of ML models is configured to extract at least one entity of a plurality of entities, wherein training comprises: accessing candidate descriptions comprising the plurality of entities; calculating a semantic distance between each of the candidate descriptions; determining, for each model of the plurality of ML models, a set of training descriptions from the candidate descriptions, wherein each description of each set of training descriptions includes the at least one entity which the model is being trained to extract, wherein each set of training descriptions comprises a first pair of descriptions, wherein the descriptions of the first pair have a first semantic distance within a first distance threshold; labeling each description of each set of training descriptions with the at least one entity which the model is being trained to extract; and providing the set of training descriptions as input to each model of the plurality of ML models to train each model of the plurality of ML models to output the at least one entity for each description of the set of training descriptions.

In some aspects, the techniques described herein relate to a computer-implemented method, wherein the at least one entity includes one of an accessor's parcel number (APN), condo unit, condo name, parking unit, building, fully subject lot, partial subject lot, condo lot, subject acreage, exceptional acreage, storage unit, block, square, subdivision, phase, state, tract, county, situs address, or metes and bounds.

The computer-implemented method of claim 1, wherein the candidate descriptions comprise text-based descriptions of property boundaries, measurements, identification of natural or artificial landmarks, geographic coordinates, public land surveys, plat or block descriptions, subdivision information, or unit information.

In some aspects, the techniques described herein relate to a computer-implemented method, wherein the plurality of ML models are large language models.

In some aspects, the techniques described herein relate to a computer-implemented method, wherein the set of training descriptions comprises a second candidate description pair, wherein the candidate descriptions of the second candidate description pair have a second semantic distance within a second distance threshold, wherein the second distance threshold is less than the first distance threshold.

In some aspects, the techniques described herein relate to a computer-implemented method, wherein the semantic distance is a Levenshtein distance.

In some aspects, the techniques described herein relate to a computer-implemented method, comprising: accessing a property description corresponding to a property; generating a prompt, the prompt to instruct a machine learning (ML) model to extract entities from the property description; providing the property description and the prompt as input to a plurality of ML models, wherein each model of the plurality of ML models is configured to extract at least one entity; extracting, by at least one model of the plurality of models, the at least one entity from the property description; and transmitting the at least one extracted entity to a public record database system, the public record database system to determine a liability corresponding to the property.

In some aspects, the techniques described herein relate to a computer-implemented method, wherein the property description comprises a text-based descriptions of property boundaries, measurements, identification of natural or artificial landmarks, geographic coordinates, public land surveys, plat or block descriptions, subdivision information, or unit information.

In some aspects, the techniques described herein relate to a computer-implemented method, further comprising retrieving the prompt and the property description from a cache.

In some aspects, the techniques described herein relate to a computer-implemented method, wherein the plurality of ML models are hosted on a cloud-based platform.

In some aspects, the techniques described herein relate to a computer-implemented method, wherein providing the property description and the prompt as input to the plurality of ML models comprises calling an API service.

In some aspects, the techniques described herein relate to a computer-implemented method, wherein the plurality of ML models are large language models.

In some aspects, the techniques described herein relate to a computer-implemented method, further comprising: receiving, from the public record database system, a result related to the liability corresponding to the property; and causing display of the result related to the liability corresponding to the property.

In some aspects, the techniques described herein relate to a computer-implemented method, further comprising training a plurality of machine learning (ML) models configured to extract at least one entity of a plurality of entities from a property description, wherein each model of the plurality is configured to extract at least one entity.

In some aspects, the techniques described herein relate to a system, comprising: a computer-readable storage medium storing program instructions; and one or more processors in communication with the computer-readable storage medium, wherein the program instructions, when executed by the one or more processors, cause the one or more processors to: access a property description corresponding to a property; generate a prompt, the prompt to instruct a machine learning (ML) model to extract entities from the property description; provide the property description and the prompt as input to a plurality of ML models, wherein each model of the plurality of ML models is configured to extract at least one entity; extract, by at least one model of the plurality of models, the at least one entity from the property description; and transmit the at least one extracted entity to a public record database system, the public record database system to determine a liability corresponding to the property.

In some aspects, the techniques described herein relate to a system, wherein the property description comprises a text-based descriptions of property boundaries, measurements, identification of natural or artificial landmarks, geographic coordinates, public land surveys, plat or block descriptions, subdivision information, or unit information.

In some aspects, the techniques described herein relate to a system, wherein the program instructions, when executed, further cause the one or more processors to retrieve the prompt and the property description from a cache.

In some aspects, the techniques described herein relate to a system, wherein the plurality of ML models are hosted on a cloud-based platform.

In some aspects, the techniques described herein relate to a system, wherein the program instructions, when executed, further cause the one or more processors to: receiving, from the public record database system, a result related to the liability corresponding to the property; and causing display of the result related to the liability corresponding to the property.

In some aspects, the techniques described herein relate to a system, wherein the program instructions, when executed, further cause the one or more processors to train a plurality of machine learning (ML) models configured to extract at least one entity of a plurality of entities from a property description, wherein each model of the plurality of ML models is configured to extract the at least one entity.

### BRIEF DESCRIPTION OF THE DRAWINGS

Various features will now be described with reference to the following drawings. Throughout the drawings, reference numbers may be re-used to indicate correspondence between referenced elements. The drawings are provided to illustrate examples described herein and are not intended to limit the scope of the disclosure.

FIG. 1 is a schematic block diagram depicting an example network environment in which an entity-based search system may operate to extract entities from legal descriptions for further property-related determinations, according to various aspects of the present disclosure.

FIG. 2 is an example data flow process in which the entity-based search system may operate to generate property interferences based on extracted entities, according to various aspects of the present disclosure.

FIG. 3 illustrates an example data flow process in which the training system may generate and utilize training data to train components of the entity-based search system, according to various aspects of the present disclosure.

FIG. 4 is a block diagram illustrating components of an example computing system that can be used to implement the various systems and methods described herein.

FIG. 5 is a flow diagram illustrating an example routine for training models to extract entities from a property description, according to various aspects of the present disclosure.

FIG. 6 is a flow diagram illustrating an example routine for extracting entities from property descriptions, according to various aspects of the present disclosure.

### DETAILED DESCRIPTION

Generally described, aspects of the present disclosure relate to efficient mechanisms for training and implementing machine learning (ML) models to extract entities from legal descriptions for further property-related determinations.

As described herein, a legal description may refer to any written statement that describes a property. Property features contained within a legal description are often used to search for additional information pertaining to the property, such as current (or former) tax liens, judgments, and other recorded liability data. However, legal descriptions may contain any number of property features (referred to herein as “entities”) that are not readily understood by untrained individuals. In addition, entities must be extracted from legal descriptions before being utilized for additional public record searching or processing. This process may lead to inaccurate determinations regarding the liabilities related to a specific property. For example, untrained individuals may misinterpret entities in legal descriptions and extract incorrect information. As a result, the untrained individuals may input incorrect information into public databases. When a user subsequently attempts to search these public databases, this database input error can result in the user receiving inaccurate search results or failing to receive otherwise accurate search results. Ultimately, this can lead to the user's time and computing resources (e.g., processing power, memory usage, network bandwidth, etc.) being wasted because the user may have to submit additional queries to the public databases or navigate to other pages to search other resources to attempt to identify accurate information.

Current solutions for entity extraction from legal descriptions often rely on traditional machine learning or rule-based solutions. For example, some existing systems implement keyword-based techniques to extract specific entities based on proximity to certain keywords entered by a user. These rule-based systems may identify specific keywords or characters that relate to a specific entity and automatically extract the following text as comprising the entity. This may overlook legal descriptions that contain errors or have different formatting. In another example, because of the multitude of entity types, some current systems may lack the capacity or the training to extract all possible combinations of entities from legal descriptions. In some cases, the use of a single model to extract all possible entities from a legal description may result in inaccurate or missing entities. Because each entity may contain or be associated with different information (e.g., different text, characters, fields, parameters, values, etc.), a single model to extract all entities may require vast training and computing resources. As such, a single model may waste computing resources, such as by requiring a large amount of training data and/or processing power to extract multiple entities simultaneously.

Embodiments disclosed herein relate to an entity-based search system for training and implementing models to extract entities from legal descriptions for further property-related determinations in a manner that overcomes the technical issues described above. Specifically, the entity-based search system comprises a plurality of entity services, each configured to access a model for extraction of a particular entity.

In a training phase, the entity-based search system may generate a set of training data to specifically train each model for extraction of a particular entity. The entity-based search system may curate a set of training based on candidate descriptions. To curate a training data set, the entity-based search system may implement distance-based calculations (e.g., semantic distances) to determine a diverse set of training descriptions. The training set may also be labeled with ground truth data corresponding to the embedded entities within the description. Because the entity-based search system as described herein includes a specific model configured to extract a particular entity, each model may be specifically trained and fine-tuned to extract said entity. This results in greater accuracy in extraction and more efficient use of training data for targeted training.

In an inference phase, the entity-based search system may access a legal description. In addition, the entity recognition system 104 may access prompts for each model to include with the legal description for input into the model. Each model may be configured to extract entities from the legal description. Extracted entities can be further used by additional processes or systems to determine property liability (e.g., tax liability) or other property-based information using the extracted entities. Because of the multiple models configured for extraction of a single entity, the entity-based search system may result in more accurately extracted entities. In addition, the use of multiple models in parallel may reduce the time taken to extract entities, whereas in a single model system, the model may need to process multiple tokens or calls for extraction.

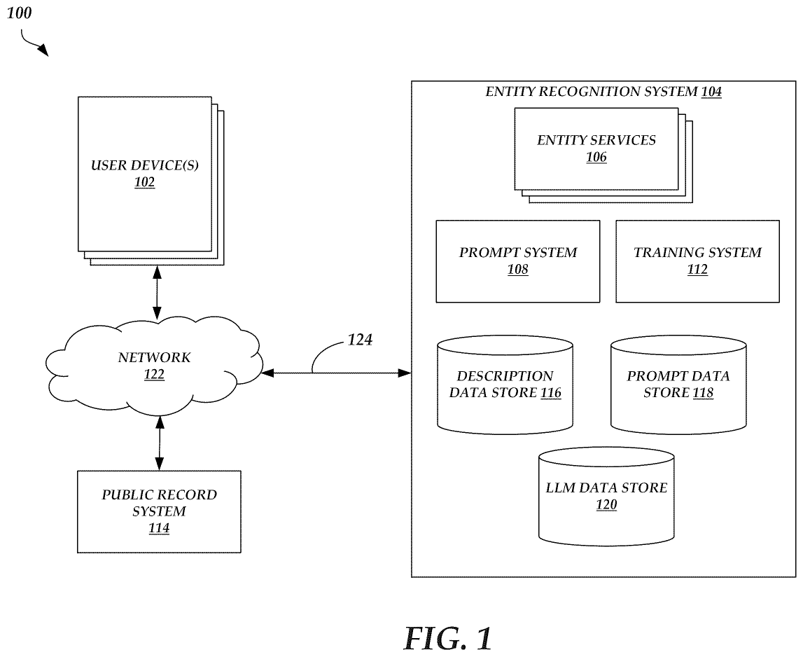

FIG. 1 is a schematic block diagram depicting an example network environment 100 in which an entity recognition system 104 may operate to extract entities from legal descriptions for further property-related determinations, according to various aspects of the present disclosure.

As shown in FIG. 1, the network environment 100 includes user device(s) 102 (hereinafter referred to as “user device 102” for ease of reference), entity recognition system 104, public record system 114, and network 122. Entity recognition system 104 includes various components such as entity services 106, prompt system 108, training system 112. In addition, the entity recognition system 104 includes various databases or data stores, such as description data store 116, prompt data store 118, and large language model (LLM) data store 120.

The components of the entity recognition system 104 may be communicatively coupled via network 122. In addition, the network 122 may connect the user device 102 to the entity recognition system 104 and various components of the entity recognition system 104. Network environment 100 and components of the network environment 100 can include various hardware components and software components and can provide functionality as described further herein. In addition, components of the network environment 100 and the entity recognition system 104 can include more or less components than as shown in FIG. 1. It is noted that the components may send and receive calls or signals from each other within the entity recognition system 104. For example, the prompt system 108 and the training system 112 may communicate with the entity services 106 via zero-shot prompting. As utilized herein, zero-shot prompting may refer to a technique in which the LLMs of the entity services 106 are instructed without providing examples or demonstrations.

In various aspects, communications among the various components of the example network environment 100 and the entity recognition system 104 may be accomplished via any suitable device, systems, methods, and/or the like. For example, the entity recognition system 104 may communicate with the user device 102 and any remote data stores (not shown), via any combination of the network 122 or any other wired or wireless communication networks, methods (e.g., Bluetooth, WiFi, infrared, cellular, and/or the like). As further described below, the network 122 may comprise, for example, one or more internal or external networks, the Internet, and/or the like.

Network 122 of the network environment 100 can include any appropriate network, including wired network, wireless network, or combination thereof. For example, network 122 may be a personal area network, local area network, wide area network, cable network, satellite network, cellular network, or any other such network or combination thereof. As a further example, the network 122 may be a publicly accessible network of linked networks, possibly operated by various distinct parties, such as the Internet. Protocols and components for communicating via the Internet or any other types of communication networks are known to those skilled in the art of computer communications and thus, need not be described in more detail herein. In various embodiments, the network 122 may be a private or semi-private network, such as a corporate or university intranet. The network 122 may include one or more wireless networks, such as a Global System for Mobile Communications (GSM) network, a Code Division Multiple Access (CDMA) network, a Long-Term Evolution (LTE) network, C-band, mmWave, sub-6 GHz, or any other type of wireless network. The network 122 can use protocols and components for communicating via the Internet or any of the other aforementioned types of networks. For example, the protocols used by the network 122 may include Hypertext Transfer Protocol (HTTP), HTTP Secure (HTTPS), Message Queue Telemetry Transport (MQTT), Constrained Application Protocol (CoAP), and the like. Protocols and components for communicating via the Internet or any of the other aforementioned types of communication networks are well known to those skilled in the art of computer communications and thus, need not be described in more detail herein.

In various implementations, the network 122 can represent a network that may be local to a particular organization, e.g., a private or semi-private network, such as a corporate or university intranet. In some implementations, devices may communicate via the network 122 without traversing an external network, such as the Internet. In some implementations, devices connected via the network 122 may be walled off from accessing the Internet. As an example, the network 122 may not be connected to the Internet. Accordingly, e.g., the user device 102 may communicate with the entity recognition system 104 directly (via wired or wireless communications) or via the network 122, without using the Internet. Thus, even if the network 122 or the Internet is down, the entity recognition system 104 may continue to communicate and function via direct communications (and/or via the network 122).

User device 102 may be used to access various components of the network environment 100 and the entity recognition system 104 over the network 122. User device 102 illustratively correspond to any computing device that provides a means for a user or admin to interact with components of the entity recognition system 104. For example, a user, with user device 102, may access the entity recognition system 104 to extract entities from a legal description for use in a public record database search. In some examples, the user may utilize a frontend implemented on the user device 102 to access the entity recognition system 104. Of course, other activities may also be performed by a user with a user device 102. User device 102 may include user interfaces or dashboards that connect a user with a machine, system, or device. In various implementations, user device 102 include computer devices with a display and a mechanism for user input (e.g., mouse, keyboard, voice recognition, touch screen, and/or the like). In various implementations, the user device 102 include desktops, tablets, e-readers, servers, wearable device, laptops, smartphones, computers, gaming consoles, and the like. In some implementations, user device 102 can access a cloud provider network via the network 122 to view or manage their data and computing resources, as well as to use websites and/or applications hosted by the cloud provider network. Elements of the cloud provider network may also act as clients to other elements of that network. Thus, user device 102 can generally refer to any device accessing a network-accessible service as a client of that service.

Entity recognition system 104 may be configured to extract entities from legal descriptions for further property-related determinations. Entity recognition system 104 can comprise various systems or modules configured to execute processes directed to extracting and processing extracted entities. Entity recognition system 104 can include the components as shown in FIG. 1 but can also include more or less components in additional embodiments. Each component of the entity recognition system 104 will be discussed in turn.

In some embodiments, entity recognition system 104 and components of the entity recognition system 104 may be hosted on a cloud-based platform or application and accessible by the user device 102 via API calls. As shown in FIG. 1, the user device 102 may access the entity recognition system 104 via API call 124 (or multiple calls).

Description data store 116 may be configured to store legal descriptions relating to properties. As noted herein, a legal description may refer to any text-based description of a property. A legal description can include various property features, or “entities,” that indicate the property's geographical description. For example, a legal description can include a written statement that defines the boundaries of a piece of real property (e.g., parcel). The legal description can identify the precise location and measurements of the parcel. For example, the legal description can include a metes and bounds description, which can include a description that identifies the boundaries of a parcel by natural and/or artificial landmarks. The legal description can also include a public land (or “rectangular”) survey system description, which identifies the parcel using a grid of imaginary lines to demarcate the parcel. In addition, the legal description can include plat or block method descriptions, which include a permanent reference monument or control point used to identify the parcel. Alternatively, or in addition, the legal description can include one or more geographic coordinates that define a boundary of a parcel. In some embodiments, the legal description associated with a parcel can include or indicate the associated subdivision name. For example, entities can include accessor's parcel number (APN), condo unit, condo name, parking unit, building, fully subject lot, partial subject lot, condo lot, subject acreage, exceptional acreage, storage unit, block, square, subdivision, phase, state, tract, county, situs address, metes and bounds, and the like. In some embodiments, a legal description includes any combination of entities to describe a property. A sample legal description could read: “LOT 11, BLK 4, of ‘Oakwood Manor’ subdivision, AC 4.5.” In this example, the entities within the legal description include lot number (11), block number (4), subdivision information/name (Oakwood Manor), and acreage (4.5). The description data store 116 may store any number of legal descriptions for any number of properties or land parcels. Legal descriptions stored in the description data store 116 may be accessed by additional components of the entity recognition system 104.

In some embodiments, the legal descriptions (or descriptions) stored in the description data store 116 may be sourced from additional systems or processes.

Although shown in FIG. 1 within the entity recognition system 104, the description data store 116, in some embodiments, is stored in a remote location and accessed by the entity recognition system 104 over the network 122.

Entity services 106 may be configured to extract entities from legal descriptions. As noted above, legal descriptions can include any number of entities that describe the property. Entity services 106 can access various data stores, APIs, and other systems to perform extraction of the entities from legal descriptions. Entity services 106 can access data stores, such as the description data store 116 to access legal descriptions with unextracted entities. In addition, the entity services 106 can access LLMs, such as ones stored in the LLM data store 120. Based on the output of the LLMs, the entity services 106 may determine extracted entities.

In some embodiments, entity services 106 includes a plurality of entity services. In some embodiments, the entity services 106 includes an entity service to handle extraction of each entity. For example, the entity services 106 may include an entity service for acreage extraction, an entity service for lot number extraction, an entity service for block extraction, and so on.

Prompt system 108 may be configured to generate prompts to be accessed by the entity services 106 for input into LLMs (of the LLM data store 120). Prompts can include any instruction or statement for input into an LLM by the entity services 106 to initiate extraction of entities from a description. In some embodiments, prompts generated by the prompt system 108 may be generated according to manual input (such as from a user) or according to additional processes or tools, such as AI, ML, etc.

In some embodiments, the prompt system 108 generates a prompt (or multiple prompts) for each entity service of the entity services 106. For example, based on the type of entity to be extracted, the prompt system 108 may generate an entity-specific prompt to be input to the LLM for extraction of that entity.

In some embodiments, the prompts generated by the prompt system 108 include configurations at various levels of detail. In some embodiments, prompts generated by the prompt system 108 may all conform to specific global rules or limitations. For example, prompts generated to conform to global rules can take into account restrictions, compliance measures, and other constraints from a company (or organizational, etc.) perspective. In some embodiments, prompts generated by the prompt system 108 may conform to system-level restrictions, such as limitations to define each LLM persona as an expert in entity extraction for descriptions and other guidelines of output format (to ensure consistency, etc.). In some embodiments, the prompt system 108 may implement restrictions at the entity level. For example, prompting at this level can include detailed instructions on how to identify and extract required entities. Instructions included within a prompt may differ depending on which entity is to be extracted by the prompt. In addition, instructions at this level can include instructions for keyword searching, false positives exclusions, example demonstrations or illustrations, and other contextual or specific instructions. In some embodiments, the prompts generated by the prompt system 108 can also include hyperparameters and other configurations for entity extraction tasks, such as temperature, randomness parameters, safety settings, other hyperparameter settings. Any other configurations or instructions may be included in the prompts generated by the prompt system 108.

In some embodiments, the prompt system 108 generates a prompt (or multiple prompts) for each entity service of the entity services 106. For example, the prompt system 108 may generate prompts to be accessed by a specific entity service, as the prompt may include instructions for extracting a single entity from a description. In some embodiments, the prompt system 108 generates prompts that include instructions to the LLMs for extracting more than one entity from a description.

Prompt data store 118 may be configured to store prompts or instructions to be accessed by the entity services 106 for input into the LLMs (of LLM data store 120). As will be discussed in more detail below, the entity recognition system 104 (via the entity services 106) may be configured to access LLMs to extract entities from descriptions. Prompts generated by the prompt system 108 may be stored in the prompt data store 118 for access by the entity services 106.

LLM data store 120 may be configured to store LLMs to be accessed by the entity recognition system 104. LLMs stored in the LLM data store 120 may include any model, algorithm, program, etc. configured to understand and process language. Specifically, LLMs stored in the LLM data store 120 may be configured to, based on an input prompt, extract entities from a legal description. LLMs may be trained by the training system 112, which will be discussed in more detail below. In some embodiments, LLMs may be hosted on a server(s) and accessible to the entity recognition system 104 via the network 122.

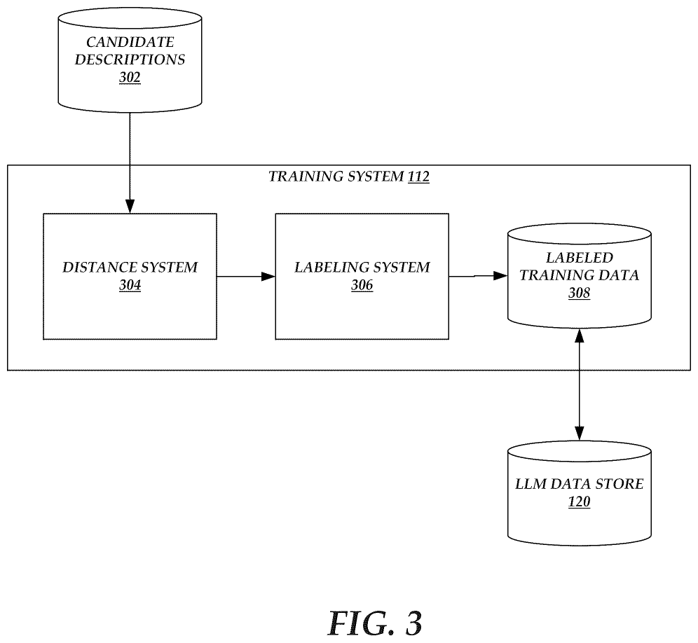

Training system 112 may be configured to train components of the entity recognition system 104. In some embodiments, the training system 112 may be configured to generate a set of training data to train the LLM(s) stored in the LLM data store 120. In some embodiments, the training system 112 may access candidate descriptions to determine the training data. In addition to generating the training data, the training system 112 may be configured to train the LLMs using the generated training data. The processes involved in generating the training data and training the LLMs will be discussed in more detail with reference to FIG. 3.

Public record system 114 may be configured to generate or determine additional inferences relating to a property based on extracted entities. In some embodiments, the public record system 114 can access additional data stores or databases, such as public records. In addition, the public record system 114 may access additional models, algorithms, processes, etc. to determine inferences relating to public records. In some embodiments, the public record system 114 may utilize models or algorithms to search for tax information, such as tax liens, judgments, and other recorded liability data. In some embodiments, the public record system 114 may generate inferences, estimates, and other determinations based on the extracted entities and public record information.

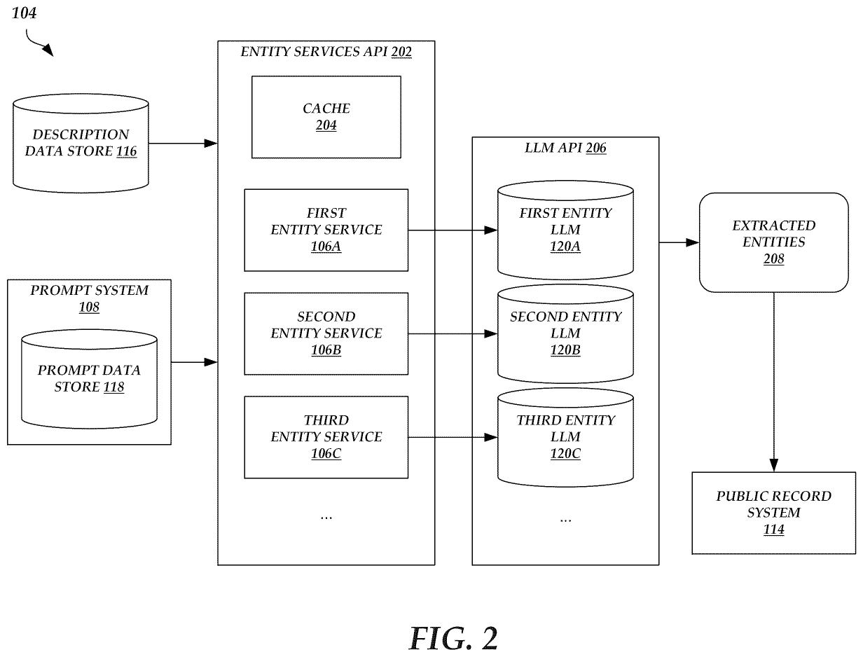

FIG. 2 is an example data flow process in which the entity recognition system 104 may operate to generate property interferences based on extracted entities, according to various aspects of the present disclosure.

In some embodiments, the entity recognition system 104 operates to extract entities from legal descriptions. As shown in FIG. 2, the entity recognition system 104 may access legal descriptions from the description data store 116. Descriptions accessed from the description data store 116 can include text-based descriptions of properties, as detailed above. In some embodiments, the entity recognition system 104 accesses multiple descriptions for entity extraction.

In some embodiments, the entity recognition system 104 may access prompt system 108 for generation of an extraction prompt. As described herein, the prompt system 108 may be configured to generate prompts for input into the LLMs (of the LLM data store 120). Prompts generated by the prompt system 108 can include any instruction or statement to initiate extraction of entities from a legal description. In addition, as described above, the prompts may include various limitations or levels of detail. Depending on the type of entity to extract, the entity recognition system 104 may access a different prompt for input into a specific entity LLM.

In some embodiments, the entity services 106 may be accessible through or hosted by an API, such as the entity services API 202. Entity services 106 can include a first entity service 106A, a second entity service 106B, a third entity service 106C, and so on. In some embodiments, each entity service may be configured to extract (or handle the extraction of) a separate entity. In addition to hosting the entity services 106, the entity services API 202 may also include a cache 204. In some embodiments, the cache 204 may store tokens, descriptions, and/or prompts that are frequently called by the entity services 106. As utilized herein, token may refer to a unit of data, such as a word, character, phrase, etc. processed by the LLMs. Specifically, the entity services 106 may convert the words of a prompt into tokens to be understood by the LLMs. In some embodiments, the call from the entity services to the LLM APIs may utilize the same tokens stored in the cache 204.

Upon accessing a description, the entity services 106 can extract entities using the LLMs. In some embodiments, each entity service (the first entity service 106A, the second entity service 106B, the third entity service 106C, etc.) may access the legal description from the description data store 116. Each entity service 106 may input the legal description and a prompt into the corresponding LLM in the LLM API 206.

As shown in FIG. 2, the entity services may access LLMs via the LLM API 206. LLMs may be accessible through or hosted by an API, such as the LLM API 206. In some embodiments, each LLM in the LLM API 206 may be configured to extract a single entity from a legal description. In one example, the first entity service 106A may access the legal description from the description data store 116 and a prompt corresponding to extraction of the first entity from the prompt data store 118. The first entity service 106A may input both the legal description and the prompt into the first entity LLM 120A. In response, the first entity LLM 120A may output an extracted entity, if at all, from the legal description. In some embodiments, the LLM may not extract an entity in the case that the legal description does not contain that entity.

As noted herein, the legal description may contain more than one entity. As such, although the legal description (and corresponding prompts) may be accessed by all the entity services in the entity services API 202, some or none of the entity services may extract an entity from the legal description. Extracted entities 208 may be collected by the entity recognition system 104 and stored in a data store (not shown). In some embodiments, the entity recognition system 104 may access additional components or processes, such as the public record system 114. In this case, the extracted entities 208 may be used by the public record system 114 to search for relevant liability information relating to the property described by the legal description.

FIG. 3 illustrates an example data flow process in which the training system 112 may generate and utilize training data to train components of the entity recognition system 104.

In some embodiments, the training system 112 may access candidate descriptions 302. Candidate descriptions 302 can include any text-based descriptions relating to properties, similar to descriptions stored in the description data store 116. Similar to descriptions stored in the description data store 116, the candidate descriptions 302 can include text-based descriptions that identify boundaries of a property (which may be a real property or a fake property for purposes of training), such as metes and bounds descriptions, measurements, identification of natural and/or artificial landmarks, geographic coordinates, public land survey system descriptions, plat/block descriptions, subdivision information, unit information, and the like. Candidate descriptions 302 can comprise a plurality of potential descriptions to be selected for inclusion within a training data set, by the training system 112. In some embodiments, candidate descriptions 302 have more than one entity.

Upon accessing or obtaining the candidate descriptions 302, the distance system 304 computes or calculates distances between the descriptions. To do so, the distance system 304 may compute a distance between each of the candidate descriptions 302, such as a Levenshtein distance and/or semantic distance. In some embodiments, the distance computed between two descriptions, calculated by the distance system 304, reflects a difference between the description strings. This can include the distance between words/characters of the descriptions in a minimum number of single-character edits. The distance system 304 can determine a distance between each combination of candidate descriptions.

In some embodiments, the distance system 304 may select or retain pairs of descriptions with distances above a threshold. This process may allow the selection of candidate descriptions that are sufficiently different from each other, which can result in a diverse training set. In some embodiments, the distance system 304 (or training system 112) may select a certain number of descriptions from the candidate descriptions 302 based on the computed distances. In some embodiments, the selection of descriptions may be based on threshold distances (e.g., above a certain distance, withing a certain distance range), threshold numbers (e.g., the training set is to have X descriptions), etc.

Upon calculating the distances between each of the candidate descriptions 302, the labeling system 306 may label each of the candidate descriptions 302. In some embodiments, the training system 112 may only input descriptions that are selected to be part of the training data set (e.g., based on distance thresholds) after calculation of the distances. In some embodiments, all candidate descriptions 302 are labeled by the labeling system 306.

In some embodiments, the labeling system 306 labels each description based on the embedded entities. In some embodiments, the labeling system 306 takes manual input from a user or other administrator to label each of the descriptions with the correct entities. In some embodiments, the labeling system 306 accesses additional systems or processes to label the descriptions. Descriptions with more than one entity may be labeled with each of the corresponding entities.

Upon selecting the descriptions from the candidate descriptions 302 based on the distances and labeling the selected descriptions, the training system 112 may store the selected/labeled descriptions as labeled training data 308. In some embodiments, the training system 112 accesses the labeled training data 308 to train LLMs stored in the LLM data store 120. In some embodiments, the training system 112 may train certain models depending on the labeled training data. For example, as noted with respect to FIG. 2, LLMs may include a model for extraction of a specific entity. Training data with descriptions labeled with certain entities can be used to train models to extract that specific entity. In some embodiments, training of the LLMs can be performed by the training system 112 prior to or during execution of processes performed by the entity recognition system 104.

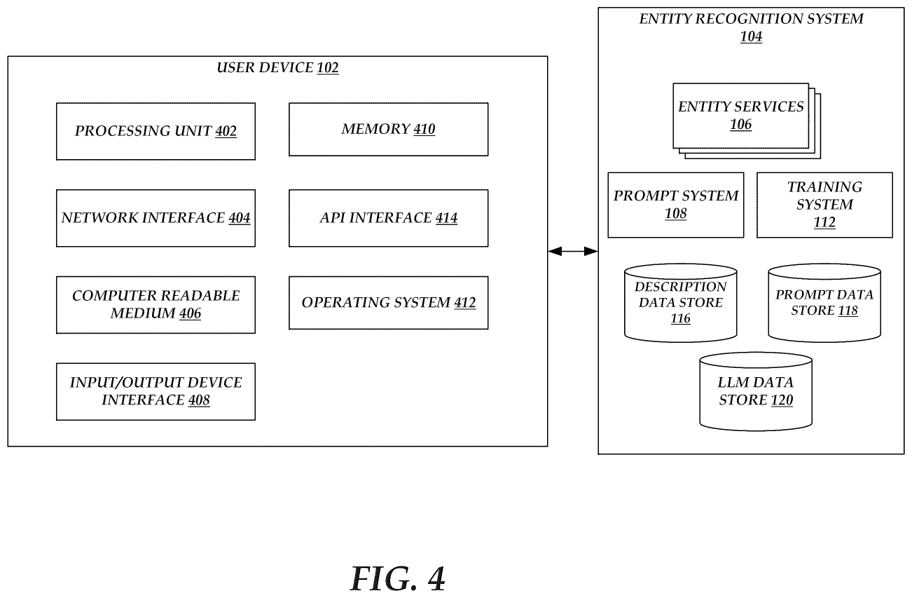

FIG. 4 is a block diagram illustrating components of an example computing system that can be used to implement the various systems and methods described herein.

The general architecture of the system depicted in FIG. 4 includes an arrangement of computer hardware and software that may be used to implement aspects of the present disclosure. The hardware may be implemented on physical electronic devices, such as user device 102, as discussed in greater detail below. The system may include many more (or fewer) elements than those shown in FIG. 4. It is not necessary, however, that all of these generally conventional elements be shown in order to provide an enabling disclosure. Additionally, the general architecture illustrated in FIG. 4 may be used to implement one or more of the other components illustrated in the figures. As illustrated, user device 102 includes a processing unit 402, a network interface 404, a computer-readable medium drive 406, and an input/output device interface 408, memory 410, operating system 412, API interface 414, all of which may communicate with one another by way of a communication bus.

The network interface 404 may provide connectivity to one or more networks or computing systems. The processing unit 402 may thus receive information and instructions from other computing systems or services via the network. The processing unit 402 may also communicate to and from memory 410 and further provide output information for an optional display (not shown) via the input/output device interface 408. The input/output device interface 408 may also accept input from an optional input device (not shown).

The memory 410 may contain computer program instructions (grouped as units in some embodiments) that the processing unit 402 executes in order to implement one or more aspects of the present disclosure, along with data used to facilitate or support such execution. While shown in FIG. 4 as a single set of memory 410, memory 410 may in practice be divided into tiers, such as primary memory and secondary memory, which tiers may include (but are not limited to) random access memory (RAM), 3D XPOINT memory, flash memory, magnetic storage, and the like. For example, primary memory may be assumed for the purposes of description to represent a main working memory of the system, with a higher speed but lower total capacity than a secondary memory, tertiary memory, etc.

Although not shown, the memory 410 may store an operating system 412 that provides computer program instructions for use by the processing unit 402 in the general administration and operation of the entity recognition system 104. The memory 410 may further include computer program instructions and other information for implementing aspects of the present disclosure.

The system of FIG. 4 is one illustrative configuration of such a user device 102, of which others are possible. For example, while shown as a single device, a system may in some embodiments be implemented as a logical device hosted by multiple physical host devices. In other embodiments, the system may be implemented as one or more virtual devices executing on a physical computing device. Also as shown, user device 102 may interact with the entity recognition system 104 and the components of the entity recognition system 104 via the API interface 414.

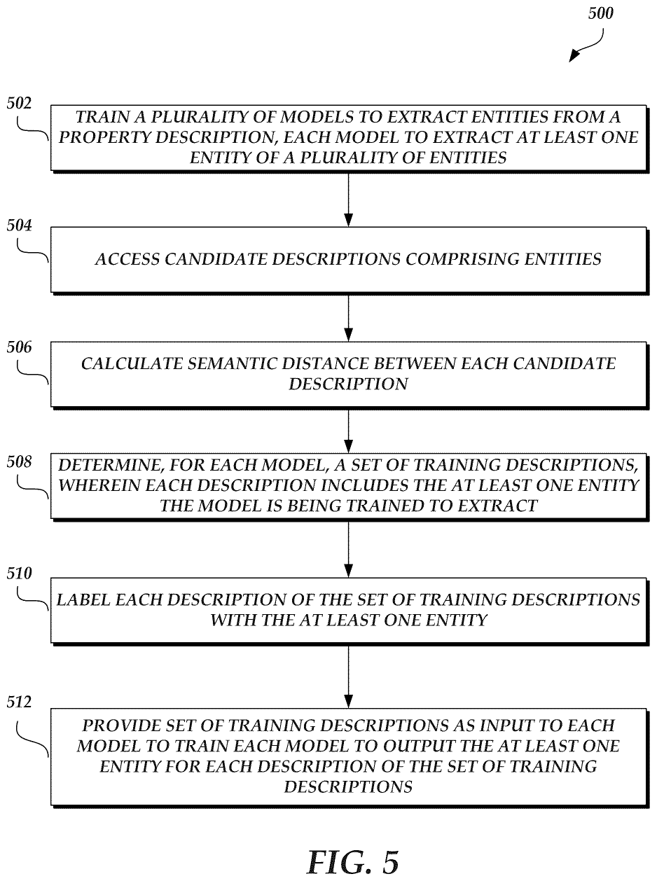

FIG. 5 is a flow diagram illustrating an example routine 500 for training models to extract entities from a property description, according to various aspects of the present disclosure. Routine 500 may comprise a computer-implemented method to be executed by the entity recognition system 104 and various components of the entity recognition system 104. Specifically, the routine 500 may be executed by a processor, such as the processing unit 402, shown in FIG. 4. As described herein, the training system 112 may be configured to train a plurality of models, such as LLMs stored in the LLM data store 120, each model to extract at least one entity from a property description.

At block 502, the training system 112 trains a plurality of models, such as machine learning models stored in the LLM data store 120, to extract entities from a property description. It is noted that the training process performed by the training system 112 is described with respect to block 504-512. The training process may be iteratively performed by the training system 112.

At block 504, the training system 112 accesses candidate descriptions 302. As described herein, the candidate descriptions 302 can include any text-based descriptions relating to properties. In some embodiments, the candidate descriptions 302 include entities, or various features relating to the properties (e.g., accessor's parcel number (APN), condo unit, condo name, parking unit, building, fully subject lot, partial subject lot, condo lot, subject acreage, exceptional acreage, storage unit, block, square, subdivision, phase, state, tract, county, situs address, metes and bounds, and the like). In some embodiments, candidate descriptions 302 correspond to real world properties and/or fake properties (for training purposes). In some embodiments, the candidate descriptions 302 may not be labeled with ground truth data, and may only include the raw text descriptions. Candidate descriptions 302 may be accessed via the network 122. Candidate descriptions 302 can comprise a plurality of potential descriptions to be selected for inclusion within a training data set, by the training system 112. In some embodiments, candidate descriptions 302 have more than one entity.

At block 506, the distance system 304 calculates semantic distances between the accessed candidate descriptions. In some embodiments, the distance system 304 calculates a distance between each of the candidate descriptions 302. Various measurement metrics may be used by the distance system 304 to calculate distances, such as a Levenshtein distance or other semantic distance metric. As noted herein, the distance between two descriptions can reflect a difference in the description strings, such as a distance between the word/characters of the descriptions. In some embodiments, the distance system 304 may calculate the differences between distances by taking into account the entire string of the descriptions. In some embodiments, the distance is measured by the distance system 304 based on a subset or portion of the descriptions. In some embodiments, the distance system 304 determines a distance between each pair of the candidate descriptions 302.

At block 508, the training system 112 (or the distance system 304) determines, for each model of the plurality of models, a set of training descriptions from the candidate descriptions. In some embodiments, each description of the set of training descriptions includes the at least one entity which the model is being trained to extract. In some embodiments, the set of training descriptions comprises at least two candidate descriptions with a semantic distance above a distance threshold. As described above, in some embodiments, the distance system 304 may select or retain pairs of descriptions with distances above a threshold. In some embodiments, the training system 112 selects descriptions with distances within a certain range. In some embodiments, the set of training descriptions comprises a first pair of descriptions, wherein the first pair of descriptions have a first semantic distance within a first distance threshold. In some embodiments, the set of training descriptions comprises a second candidate description pair, wherein the candidate descriptions of the second candidate description pair have a second semantic distance within a second distance threshold, wherein the second distance threshold is less than the first distance threshold.

At block 510, the labeling system 306 labels each description of each set of training descriptions with the at least one entity which the model is being trained to extract (e.g., ground truth entity). In some embodiments, the labeling system 306 labels each description based on the embedded entities. In some embodiments, the labeling system 306 takes manual input from a user or other administrator to label each of the descriptions with the correct entities (e.g., the ground truth data). In some embodiments, the labeling system 306 accesses additional systems or processes to label the descriptions. Descriptions with more than one entity may be labeled with each of the corresponding entities.

At block 512, the training system 112 provides each set of training descriptions as input to each model of the plurality of ML models to train each model to output the at least one entity. In some embodiments, the training system 112 inputs a set of training descriptions into each model of the plurality of ML models to train each model of the plurality of ML models to output the at least one ground truth entity for each description of the set of training descriptions. Upon selecting the descriptions from the candidate descriptions 302 based on the distances and labeling the selected descriptions, the training system 112 may store the selected/labeled descriptions as labeled training data 308. In some embodiments, the training system 112 accesses the labeled training data 308 to train LLMs stored in the LLM data store 120. In some embodiments, the training system 112 may train certain models depending on the labeled training data. For example, as noted with respect to FIG. 2, LLMs may include a model for extraction of a specific entity. Training data with descriptions labeled with certain entities can be used to train models to extract that specific entity. In some embodiments, training of the LLMs can be performed by the training system 112 prior to or during execution of processes performed by the entity recognition system 104.

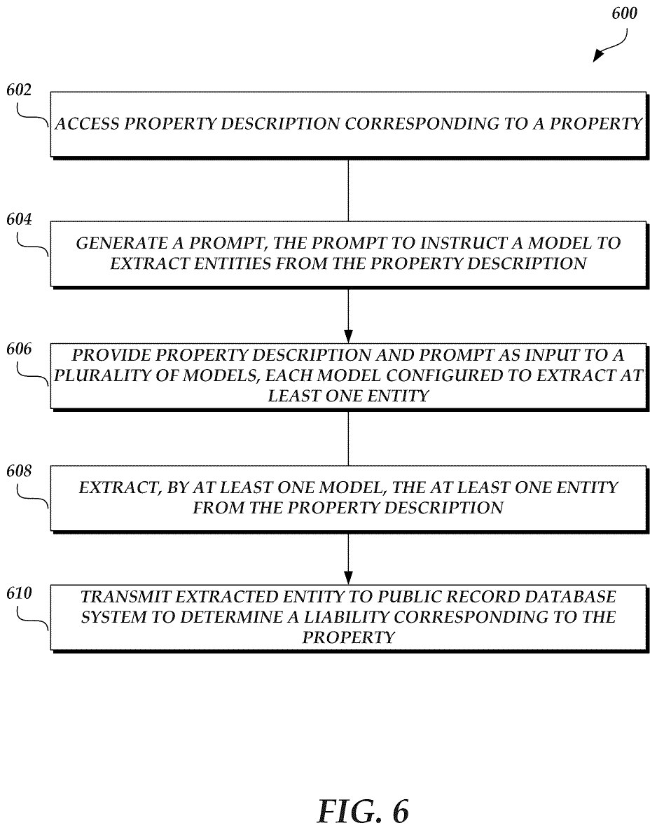

FIG. 6 is a flow diagram illustrating an example routine 600 for extracting entities from property descriptions, according to various aspects of the present disclosure. Routine 600 may be a computer-implemented method to be executed by the entity recognition system 104 and various components of the entity recognition system 104. Specifically, the routine 600 may be executed by a processor, such as the processing unit 402, shown in FIG. 4. As described herein, the entity recognition system 104 may be configured to extract entities from property descriptions using a plurality of models.

At block 602, the entity recognition system 104 accesses property descriptions. As described above, the entity services API 202 may access property descriptions from the description data store 116. In some embodiments, each entity service (106A, 106B, etc.) may obtain the same description from the description data store 116. Each entity service may be configured to extract an entity from the description, so the same description may be accessed by each of the entity services 106 to determine whether an entity can be extracted.

At block 604, the entity recognition system 104 generates a prompt to instruct a model to extract entities from a property description. In some embodiments, the entity recognition system 104 accesses the prompt system 108. As noted above, the prompt system 108 may be configured to generate prompts for input into the LLMs. Prompts generated by the prompt system 108 can include any instruction or statement to initiate extraction of entities from a legal description. In addition, as described above, the prompts may include various limitations or levels of detail. Depending on the type of entity to extract, the entity recognition system 104 may access a different prompt for input into a specific entity LLM.

Upon accessing a description, the entity services 106 can extract entities using the LLMs. In some embodiments, each entity service (the first entity service 106A, the second entity service 106B, the third entity service 106C, etc.) may access the legal description from the description data store 116. Each entity service 106 may input the legal description and a prompt into the corresponding LLM in the LLM API 206.

At block 606, the entity services 106 provides the property description and prompt as input into a model configured to extract an entity from the property description. As shown in FIG. 2, the entity services may access LLMs via the LLM API 206. LLMs may be accessible through or hosted by an API, such as the LLM API 206. In some embodiments, each LLM in the LLM API 206 may be configured to extract a single entity from a legal description. In one example, the first entity service 106A may access the legal description from the description data store 116 and a prompt corresponding to extraction of the first entity from the prompt data store 118. The first entity service 106A may input both the legal description and the prompt into the first entity LLM 120A. In response, the first entity LLM 120A may output an extracted entity, if at all, from the legal description. In some embodiments, the LLM may not extract an entity in the case that the legal description does not contain that entity.

At block 608, at least one model of the plurality of models may extract at least one entity from the property description. As noted herein, the legal or property description may contain more than one entity. As such, although the legal description (and corresponding prompts) may be accessed by all the entity services in the entity services API 202, some or none of the entity services may extract an entity from the legal description. Extracted entities 208 may be collected by the entity recognition system 104 and stored in a data store (not shown). In some embodiments, the entity recognition system 104 may access additional components or processes, such as the public record system 114. In this case, the extracted entities 208 may be used by the public record system 114 to search for relevant liability information relating to the property described by the legal description.

At block 610, the entity recognition system 104 transmits the extracted entity to a public record system 114. Extracted entities may be used by the public record system 114 to search for relevant liability information relating to the property described by the legal description. In some embodiments, additional actions may be performed by the public record system 114 based on the extracted entities. For example, the public record system 114 may retrieve documents or information pertaining to property liability found through the searching of public databases or records (using the extracted entities as search input). In some embodiments, the public record system 114 may request additional information needed in addition to the extracted entities for searching. Public record system 114 may transmit results to a user or user device for display to a user. Notifications, alerts, and other reports may be generated by the public record system 114 based on search results. In some embodiments, the entity recognition system 104 may receive results from the public record system 114. In addition, the entity recognition system 104 may cause display of the results.

All of the methods and tasks described herein may be performed and fully automated by a computer system. The computer system may, in some cases, include multiple distinct computers or computing devices (e.g., physical servers, workstations, storage arrays, cloud computing resources, etc.) that communicate and interoperate over a network to perform the described functions. Each such computing device typically includes a processor (or multiple processors) that executes program instructions or modules stored in a memory or other non-transitory computer-readable storage medium or device (e.g., solid state storage devices, disk drives, etc.). The various functions disclosed herein may be embodied in such program instructions or may be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid-state memory chips or magnetic disks, into a different state. In some embodiments, the computer system is a cloud-based computing system whose processing resources are shared by multiple distinct business entities or other users.

Some or all of the statistical analysis methods described herein may be performed and fully automated by a computer system. The computer system may, in some cases, include multiple distinct computers or computing devices (e.g., physical servers, workstations, storage arrays, cloud computing resources, etc.) that communicate and interoperate over a network to perform the described functions. Each such computing device typically includes a processor (or multiple processors) that executes program instructions or modules stored in a memory or other non-transitory computer-readable storage medium or device (e.g., solid state storage devices, disk drives, etc.). The various functions disclosed herein may be embodied in such program instructions, or may be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid-state memory chips or magnetic disks, into a different state. In some embodiments, the computer system may be a cloud-based computing system whose processing resources are shared by multiple distinct business entities or other users.

The processes described herein or illustrated in the figures of the present disclosure may begin in response to an event, such as on a predetermined or dynamically determined schedule, on demand when initiated by a user or system administrator, or in response to some other event. When such processes are initiated, a set of executable program instructions stored on one or more non-transitory computer-readable media (e.g., hard drive, flash memory, removable media, etc.) may be loaded into memory (e.g., RAM) of a server or other computing device. The executable instructions may then be executed by a hardware-based computer processor of the computing device. In some embodiments, such processes or portions thereof may be implemented on multiple computing devices and/or multiple processors, serially or in parallel.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm elements described in connection with the embodiments disclosed herein can be implemented as electronic hardware (e.g., ASICs or FPGA devices), computer software that runs on computer hardware, or combinations of both. Moreover, the various illustrative logical blocks and modules described in connection with the embodiments disclosed herein can be implemented or performed by a machine, such as a processor device, a digital signal processor (“DSP”), an application specific integrated circuit (“ASIC”), a field programmable gate array (“FPGA”) or other programmable logic device, discrete gate or transistor logic, discrete hardware components, or any combination thereof designed to perform the functions described herein. A processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the rendering techniques described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements or steps. Thus, such conditional language is not generally intended to imply that features, elements or steps are in any way required for one or more embodiments or that one or more embodiments necessarily include logic for deciding, with or without other input or prompting, whether these features, elements or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, or Z). Thus, such disjunctive language is not generally intended to, and should not, imply that certain embodiments require at least one of X, at least one of Y, and at least one of Z to each be present.

Unless otherwise explicitly stated, articles such as “a” or “an” should generally be interpreted to include one or more described items throughout this application. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C. Unless otherwise explicitly stated, the terms “set” and “collection” should generally be interpreted to include one or more described items throughout this application. Accordingly, phrases such as “a set of devices configured to” or “a collection of devices configured to” are intended to include one or more recited devices. Such one or more recited devices can also be collectively configured to carry out the stated recitations. For example, “a set of servers configured to carry out recitations A, B and C” can include a first server configured to carry out recitation A working in conjunction with a second server configured to carry out recitations B and C.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. All changes which come within the meaning and range of equivalency of the claims are to be embraced within their scope.

What is claimed is:

1. A computer-implemented method, comprising:
training a plurality of machine learning (ML) models to extract entities from a property description, wherein each model of the plurality of ML models is configured to extract at least one entity of a plurality of entities, wherein training comprises:
accessing candidate descriptions comprising the plurality of entities;
calculating a semantic distance between each of the candidate descriptions;
determining, for each model of the plurality of ML models, a set of training descriptions from the candidate descriptions, wherein each description of each set of training descriptions includes the at least one entity which the model is being trained to extract,
wherein each set of training descriptions comprises a first pair of descriptions, wherein the descriptions of the first pair have a first semantic distance within a first distance threshold;
labeling each description of each set of training descriptions with the at least one entity which the model is being trained to extract; and
providing the set of training descriptions as input to each model of the plurality of ML models to train each model of the plurality of ML models to output the at least one entity for each description of the set of training descriptions.

2. The computer-implemented method of claim 1, wherein the at least one entity includes one of an accessor's parcel number (APN), condo unit, condo name, parking unit, building, fully subject lot, partial subject lot, condo lot, subject acreage, exceptional acreage, storage unit, block, square, subdivision, phase, state, tract, county, situs address, or metes and bounds.

3. The computer-implemented method of claim 1, wherein the candidate descriptions comprise text-based descriptions of property boundaries, measurements, identification of natural or artificial landmarks, geographic coordinates, public land surveys, plat or block descriptions, subdivision information, or unit information.

4. The computer-implemented method of claim 1, wherein the plurality of ML models are large language models.

5. The computer-implemented method of claim 1, wherein the set of training descriptions comprises a second candidate description pair, wherein the candidate descriptions of the second candidate description pair have a second semantic distance within a second distance threshold, wherein the second distance threshold is less than the first distance threshold.

6. The computer-implemented method of claim 1, wherein the semantic distance is a Levenshtein distance.

7. A computer-implemented method, comprising:
accessing a property description corresponding to a property;
generating a prompt, the prompt to instruct a machine learning (ML) model to extract entities from the property description;
providing the property description and the prompt as input to a plurality of ML models, wherein each model of the plurality of ML models is configured to extract at least one entity;
extracting, by at least one model of the plurality of models, the at least one entity from the property description; and
transmitting the at least one extracted entity to a public record database system, the public record database system to determine a liability corresponding to the property.

8. The computer-implemented method of claim 7, wherein the property description comprises a text-based descriptions of property boundaries, measurements, identification of natural or artificial landmarks, geographic coordinates, public land surveys, plat or block descriptions, subdivision information, or unit information.

9. The computer-implemented method of claim 7, further comprising retrieving the prompt and the property description from a cache.

10. The computer-implemented method of claim 7, wherein the plurality of ML models are hosted on a cloud-based platform.

11. The computer-implemented method of claim 7, wherein providing the property description and the prompt as input to the plurality of ML models comprises calling an API service.

12. The computer-implemented method of claim 7, wherein the plurality of ML models are large language models.

13. The computer-implemented method of claim 7, further comprising:
receiving, from the public record database system, a result related to the liability corresponding to the property; and
causing display of the result related to the liability corresponding to the property.

14. The computer-implemented method of claim 7, further comprising training a plurality of machine learning (ML) models configured to extract at least one entity of a plurality of entities from a property description, wherein each model of the plurality is configured to extract at least one entity.

15. A system, comprising:
a computer-readable storage medium storing program instructions; and
one or more processors in communication with the computer-readable storage medium, wherein the program instructions, when executed by the one or more processors, cause the one or more processors to:
access a property description corresponding to a property;
generate a prompt, the prompt to instruct a machine learning (ML) model to extract entities from the property description;
provide the property description and the prompt as input to a plurality of ML models, wherein each model of the plurality of ML models is configured to extract at least one entity;
extract, by at least one model of the plurality of models, the at least one entity from the property description; and
transmit the at least one extracted entity to a public record database system, the public record database system to determine a liability corresponding to the property.

16. The system of claim 15, wherein the property description comprises a text-based descriptions of property boundaries, measurements, identification of natural or artificial landmarks, geographic coordinates, public land surveys, plat or block descriptions, subdivision information, or unit information.

17. The system of claim 15, wherein the program instructions, when executed, further cause the one or more processors to retrieve the prompt and the property description from a cache.

18. The system of claim 15, wherein the plurality of ML models are hosted on a cloud-based platform.

19. The system of claim 15, wherein the program instructions, when executed, further cause the one or more processors to:
receiving, from the public record database system, a result related to the liability corresponding to the property; and
causing display of the result related to the liability corresponding to the property.

20. The system of claim 15, wherein the program instructions, when executed, further cause the one or more processors to train a plurality of machine learning (ML) models configured to extract at least one entity of a plurality of entities from a property description, wherein each model of the plurality of ML models is configured to extract the at least one entity.
